(19) United States
(12) Patent Application Publication
(10) Pub. No.: US 2011/0075598 A1
(43) Pub. Date: Mar. 31, 2011

(54) METHOD AND APPARATUS TO SHORTEN THE TIME TO CONNECT TO A NETWORK

(76) Inventors: Marc JALFON, Zichron Yaakov (IL); Raz Bareket, Haifa (IL)

(21) Appl. No.: 12/570,262

(22) Filed: Sep. 30, 2009

(51) Int. Cl. G08C 17/00

(52) U.S. Cl. 370/311

(57) ABSTRACT

A computer platform and computer method may, when a computer platform is in a low-power or sleep mode, operate a wireless communication interface unit to scan for a set of available networks and record the set of networks. When the platform is changed to an operating mode, the platform may use the set of available networks to connect to a network.

### BACKGROUND

Computer based systems capable of communicating via wireless local area network (WLAN) may be also capable of switching their operating mode into one or more standby modes, such as sleep modes notated S0-S5, according to advanced configuration and power interface (ACPI) specification. Standby modes of computers are also known as sleep modes, power-save modes and hibernate modes, and the like. When a computer system is switched into a sleep mode its WLAN interface unit (known also as Wireless MC) may stop its functionality. When the computer system is switched back into an operational mode its WLAN interface unit restarts its normal operation by responding to a request from the computer to provide a list or set of available WLAN networks. The WLAN interface unit scans all WLAN supported channels for WLAN access points, in order to provide a list of the available networks. Given the large number of supported networks and/or channels; given the scan time for a single channel which may be, typically, more than 100 ms; and given that for certain networks, for example networks with hidden service set identifier (SSID), the scan time is even longer, the total scanning time of the WLAN interface unit upon resuming from a sleep mode may accumulate to several seconds.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings in which:

FIG. 1A is schematic block diagram of a communication system according to embodiments of the present invention; and

FIG. 1B is a schematic block diagram of a computer platform according to embodiments of the present invention;

FIG. 1C is a schematic block diagram of an interface unit according to some embodiments of the present invention;

FIG. 2A is a schematic flow diagram of a method according to an embodiment of the present invention; and

FIG. 2B is a schematic flow diagram of a method of operation of a WLAN interface unit according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of embodiments of the invention. However, it will be understood by those of ordinary skill in the art that embodiments of the present invention may be practiced without these specific details. In other instances, well-known methods, procedures, components and circuits have not been described in detail so as not to obscure embodiments of the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or computer platform, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention include devices for performing the operations herein. These devices may be specially constructed for the desired purposes, or may include a general-purpose computer executing a computer program. Such a computer program may be stored in a computer readable storage medium, such as, but not limited to, any type of disk, including floppy disks, optical disks, magnetic-optical disks, read-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing electronic instructions and capable of being coupled to a computer system bus.

It should be appreciated that some embodiments of the present invention may be implemented by specific hardware that may contain hardwired logic for performing the operations, or by any combination of programmed computer components and custom hardware components.

Embodiments of the present invention may be provided as a computer program product or device that may include a machine-readable medium having stored thereon instructions that may be executed by a computer or processor (or other electronic devices) to perform a method. For the purposes of this specification, the terms “machine-readable medium” may include any medium that is capable of storing or encoding a sequence of instructions for execution by the machine and that cause the machine to perform any one of the methodologies of embodiments of the present invention. The term “machine-readable medium” may accordingly include, but is not limited to, solid-state memories, optical and magnetic disks, and a carrier wave that encodes a data signal.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of embodiments of the invention as described herein.

Although the scope of embodiments of the present invention is not limited in this respect, the system and method disclosed herein may be implemented in wireless, handheld and portable communication devices, such as wireless desktop computers and wireless, handheld and portable communication devices may include wireless and cellular telephones, smart telephones, personal digital assistants (PDAs), web-tablets, personal computers or laptop computers with wireless capability, access points, stations, and any device that may provide wireless access to a network such, an intranet or the Internet. It should be understood that embodiments of the present invention may be used in a variety of applications.

In one embodiment, a computer platform may be adapted to switch to a standby, hibernate, sleep or other low-power mode, for example in order to save power. The platform may switch to a low-power mode for example when the computer platform is not performing (or has not performed for a certain period of time) any input-output (I/O) operations, such as receiving input from a keyboard, a mouse, and the like or providing output, such presenting new data on a screen or monitor. A standby or other low-power mode may be a mode having one or more levels, the levels typically differing from each other in how the system maintains operational parameters and data in the registers or memories of the computer platform, in order to make these data items readily available for the computer platform when it resumes from standby mode to an active mode. However, standby modes typically have power consumption lower than in an active or fully awake mode.

A station, such as a portable computer, a cellular phone, a personal digital assistant (PDA) and the like, which is in an active communication with one or more wireless communication networks may experience changes in the availability of one or more of the wireless networks, for example due to changes in the reception conditions, for example due to the mobility of the station and/or the movement of other, ad-hoc, members of the wireless communication networks. Accordingly, the availability of wireless communication networks to a given station may change over time. A station logging on to or associating with a given wireless communication network may participate in a process in which for example the station and the network negotiate or investigate the possibility of the station logging on to the network. In a station having or part of a computer platform that is capable of wireless communication, a wireless interface unit or other unit typically scans, according to a given scheme, the availability of wireless channels for the computer platform. The list or set of available wireless networks may be stored in a storage location for later use. This list may be presented to a user of the computer platform, for example in order to allow the user to select a wireless network according to user needs. In some operation schemes a prioritized list of wireless networks may be defined in advance and if one (or more) of these wireless networks is available for the computer platform, the computer platform may select that network and connect the computer platform to that network. If more than one wireless network from the pre-defined list of priority networks is available, the computer platform may select one of these networks according to for example a pre-defined priority rule.

When a station having a computer platform is switched to a sleep, standby or low power mode most of its components may be disconnected from a power supply. Components that may be disconnected vary according to the specific standby mode or level but often include memory components that may be used to save the computer platform context (e.g., the content of all registers and stages of operation of the processor), or to save only content of registers, or to save other portions of memory. In some modes the system's context may be saved in a non-volatile memory, such as a flash memory, to enable full restoration of the platform operation upon resuming from the standby mode. In other standby modes the system's context may be saved to for example a hard disk drive. Resuming from a standby mode may occur in response to a specific sequence of key strokes, in response to a movement of a pointing device of the platform, or in response to the receipt, via a communication channel of the platform, a defined type of input. Other “wake up” events may be used.

When the computer platform resumes from a standby mode its wireless communication interface unit or functionality may be powered and may be requested by the platform to provide an updated list or set of available WLAN networks. In response the wireless communication interface unit resumes operation and may scan available wireless communication networks and/or channels, detecting available networks and transferring a list of the detected networks to the computer platform. If the computer platform was in a standby mode for a long time, the list of available wireless networks detected after resuming from standby mode may be different from that detected before switching to a standby mode, due to the dynamic nature of the WLAN networks and their ad-hoc members. The operation of the wireless interface unit while scanning available wireless communication channels is longer the larger the number of received wireless networks grows, and may be even longer if one or more of the received wireless networks has a hidden service set identifier (SSID). Additionally, the longer a prioritized list of preferred networks is the longer is the scan time. The scan time of the wireless interface unit may be as long as several seconds.

According to embodiments of the present invention, a wireless interface unit of a computer platform may be operated at scheduled time periods, e.g., cyclically for a short period of time each cycle, possibly regularly or periodically when the computer platform is in standby or other low power mode, in order to scan the availability of wireless communication networks and to record and update a list of these available wireless networks, for later use by the computer platform. When the computer platform resumes from the standby mode the most recently updated list of available wireless networks may be transferred to a memory storage of the of the computer platform, in order to be used by its processor, obviating the need for the platform to wait for a scan of available networks upon waking. In other embodiments such a transfer is not needed; e.g., the original list may be written directly to a memory used by the overall platform, or the platform may access a memory within the wireless interface unit.

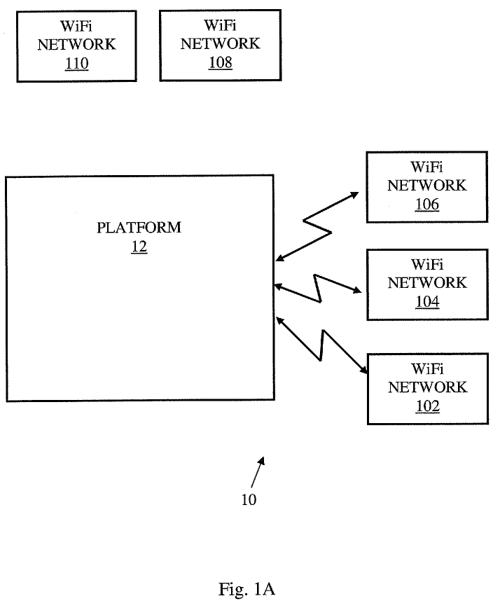

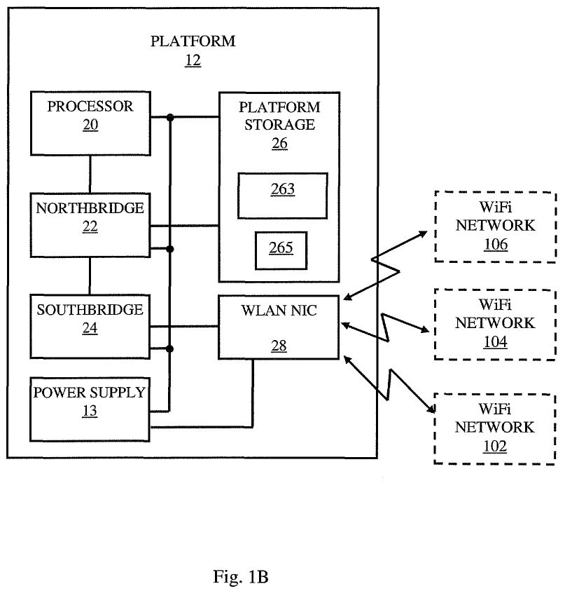

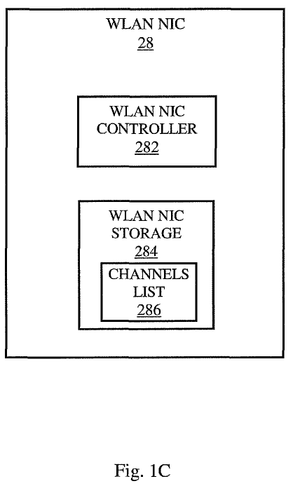

Reference is made to FIG. 1A, which is a schematic block diagram of a communication system 10, according to embodiments of the present invention. Communication system 10 includes a computer platform 12 capable of communicating with one or more WLAN networks and establishing WLAN networks 102, 104, 106. Computer platform 12 may be also in a receiving range from WLAN networks 108 and 110, however logging on to WLAN networks 108 and 110 may fail due to, for example, too low quality of reception or due to denial by the WLAN network. While the term “WLAN” is used herein other wireless systems may be used with embodiments of the invention.

Reference is made now to FIG. 1B, which is a schematic block diagram of a computer platform 12 according to embodiments of the present invention. Computer platform 12 may include processor 20, platform storage 26 and WLAN or other network interface unit 28. WLAN interface unit 28 need not be within computer platform 12, but may be associated with computer platform 12 in another manner. Computer platform 12 may further include a first controller 22 to control the communication transport between processor 20 and platform storage 26 (called in some configurations Northbridge or memory controller hub) and a second controller 24 to control communication transport between processor 20 and WLAN interface unit 28 (called in some configurations Southbridge or I/O controller). It will be apparent to one skilled in the art that the communication between processor 20 and platform storage 26 and/or communication between processor 20 and WLAN interface unit 28 may be carried out in other ways and configurations. Processor 20, platform storage 26, WLAN interface unit 28, first controller 22 and second controller 24 may be embodied in one unit or in one chip and may be embodied in separated units or cards.

Computer platform 12 includes also one or more power supply unit(s) 13 for providing power to components of platform 12. Power supply unit 13 may be any known source or sources of power that may be placed outside or inside platform 12. Power supply unit 13 may provide power to components of platform 12 according to power control scheme or schemes, for example according to a scheme enabling switching into or out of hibernate, low power or sleep mode. According to embodiments of the present invention WLAN interface unit 28 may be powered by power supply unit 13 independently from other components of computer platform 12 and thus may enable switching WLAN interface unit 28 into or out of sleep mode independently from the operational mode of other components of computer platform 12. However, such independent power may not be used in other embodiments of the invention.

Platform storage 26 may be used for storing data, control commands or software, and the like, for use by processor 20 and any other component included in computer platform 12. Platform storage may be embodied for example in one or more or a combination of a hard drive, a nonvolatile random access memory (RAM), a dynamic RAM (DRAM), a flash memory and the like. Platform storage 26 may include one or more storage locations 263 that may in some embodiments function as machine-readable medium for storing computer program products that may include instructions that may be used to program processor 20. Platform storage 26 may further include one or more storage locations 265 for storing data including but not exclusively a list or set of available wireless communication channels and/or networks (the list or set may be stored elsewhere).

Reference is made now to FIG. 1C, which is a schematic block diagram of WLAN interface unit 28 according to some embodiments of the present invention. WLAN interface unit 28 may include a local controller 282 capable of controlling the functionalities of WLAN interface unit 28, of identifying scanned WLAN supported networks and of recording a list of such networks in local storage 284. In other embodiments, a set of networks may be stored outside WLAN interface unit 28 (e.g., in storage 26), and local storage 284 need not be used to store a list of identified networks. Local controller 282 of WLAN interface unit 28 is capable of receiving signals from for example processor 20 indicating that computer platform 12 is switching into or out of sleep mode. Local controller 282 may also be capable of providing content stored in local storage 284 of WLAN interface unit 28 to processor 20 for storing in platform storage 26 and capable of storing content received from processor 20 in local storage 284. Local storage 284 may include list storage 286 for storing an updated list of available WLAN communication networks.

Computer platform 12 may be capable of being switched into a sleep mode or other low power or power save mode and of being switched out of the sleep or power save mode into an operational mode. When computer platform 12 is in a sleep mode processor 20 may be inactive and read or write operations to and platform storage 26 may be stopped. Typically when computer platform 12 is in a sleep mode the supply of power to processor 20, platform storage 26 and first and second controllers 22, 24 from power supply unit 13 is disconnected or restricted to a very low power, according to specific configuration and requirements. In some sleep modes all system parameters and registers data may be saved to nonvolatile memory storage such as flash memory or hard disk. In such a sleep mode no or little power may be consumed by the system. In other sleep modes some content of the system, such as RAM content, is maintained. In such sleep modes some power may be required to maintain the content of the RAM. According to embodiments of the present invention when computer platform 12 is switched into sleep mode power supply to WLAN interface unit 28 is maintains power supply to enable intermittent normal operation. Power to WLAN interface unit 28 may be supplied via a dedicated power line of computer platform 12, via power line from a source external to computer platform 12 (not shown) or in any other way, according to a specific configuration and requirements.

When computer platform 12 switches into a specific sleep or low power mode, content and data items that need to be maintained are either saved onto a temporary non-volatile memory device, such as flash memory or hard disk or maintained in their registers or memory location, prior to the switching power off from those components which are to be disconnected from power during sleep mode. In other sleep mode data in data registers may be maintained using a low-power mode of operation, as may be applicable according to the specific features of the memory unit used for this storage. When computer platform 12 switches out of a sleep mode to resuming, the operations are substantially reverse of the operations taken when switching into the sleep mode, so that when the resuming operations finish computer platform 12 is restored to the state and content it was in and had prior to the switching into the sleep mode.

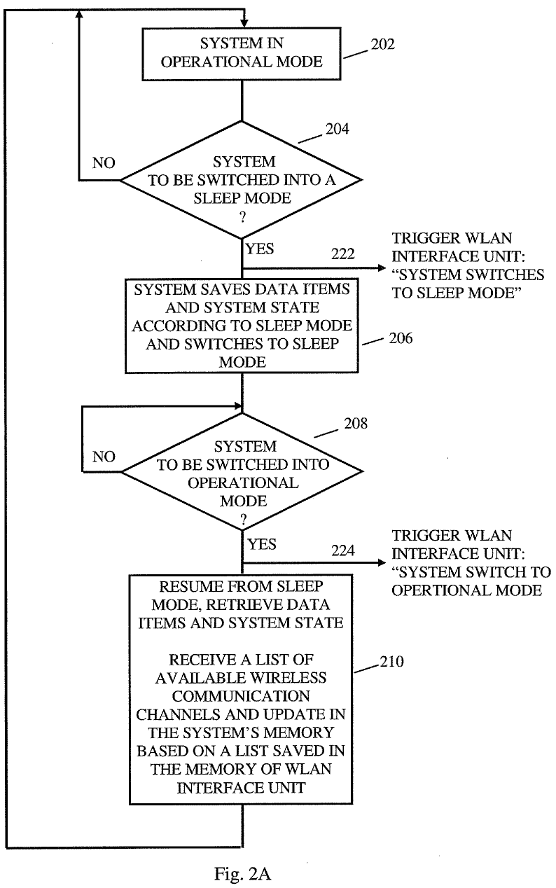

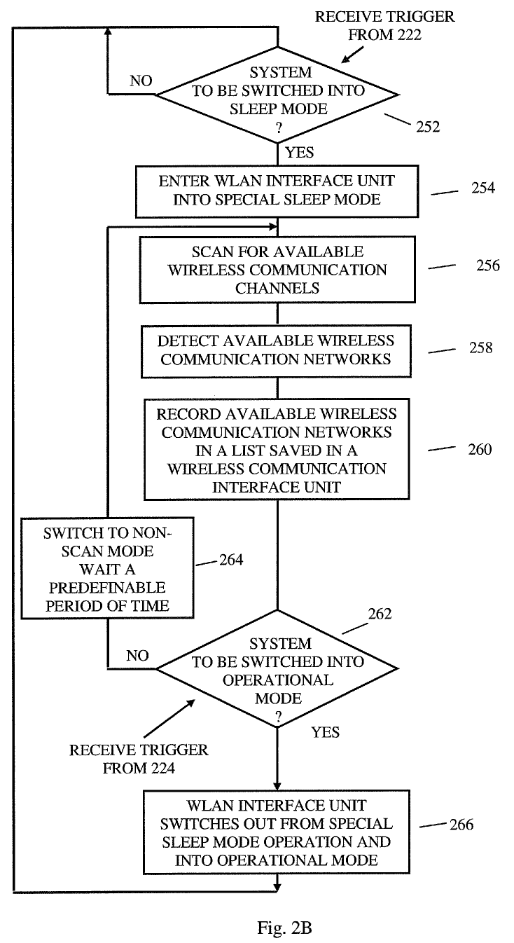

Reference is made to FIG. 2A, which is a schematic flow diagram of a method according to an embodiment of the invention. While the method according to one embodiment is described with respect to the system of FIGS. 1A, 1B and 1C, other systems with other components may operate embodiments of the present invention. Computer platform 12 may be at certain times in an operational mode (block 202) and in other times in a sleep mode or other power save mode such as hibernate mode (block 206). When computer platform is in an operational mode it may continuously check for a trigger to switch into a sleep mode (block 204). A trigger to switch into a sleep mode may be received from computer platform 12, for example due to the fact that no input was received or output was produced in computer platform 12 over a period of time longer than a definable value, or due to any other event that may be defined in computer platform 12 as triggering switching into a sleep mode. When a trigger to switch into a sleep mode is detected a trigger to WLAN interface unit 28 is sent (line 222), computer platform saves data items and system state, for example according to the type or level of the sleep mode and then computer platform 12 switches to the sleep mode (block 206). Computer platform stays in sleep mode until a trigger to switch out of sleep mode is received (block 208).

A trigger to switch out of sleep mode may be received, for example, from a I/O interface unit (not shown) which may identify an input such as a key stroke in a keyboard, a movement of a pointing device or any other event that may be defined in computer platform 12 as triggering switching out of sleep mode. The receipt of an event triggering to switch out of the sleep mode may be detected (block 208) and a respective trigger may be sent to WLAN interface unit 28 (line 224). When an event to switch out of the sleep mode is detected computer platform 12 resumes from the sleep mode by retrieving data items and system state and resuming the operational state computer platform was in prior to switching into the sleep mode (block 210). Platform 12 resuming normal operation or waking may include certain components, e.g. a memory and a processor, resuming normal operation or returning to an operating mode. Processor 20 may receive from WLAN interface unit 28 a list of available wireless communication networks and using that list update a list saved for example in storage location 265 in platform storage 26 (block 210). The operation of resuming from the sleep mode and updating the list of available WLAN communication networks ends, and computer platform 12 may function according to the programs that may be operative and controls that may be received (block 202), until computer platform switches once more into a sleep mode.

Reference is made now also to FIG. 2B, which is schematic flow diagram of a method of operation of WLAN interface unit 28 according to embodiments of the present invention. While the method according to one embodiment is described with respect to the system of FIGS. 1A, 1B and 1C, other systems with other components may operate embodiments of the present invention. WLAN interface unit 28 may check, in decision point 252, whether computer platform 12 is in operational mode or is switching into a sleep or other low-power mode, according to trigger from line 222 (FIG. 2A). When computer platform 12 is in operational mode, which may be for example a full power mode (block 202) computer platform may perform any functionality, for example executing tasks and programs. Additionally, computer platform 12 may receive, substantially immediately after computer platform 12 resumes from sleep or other low power mode, from local storage 284 of WLAN interface unit 28, a list of available WLAN or other networks. Alternately, computer platform 12 may have access to a list of available networks stored in WLAN interface unit 28. As part of a process of resuming operation from sleep mode computer platform 12 may store the list of available WLAN networks in a dedicated storage location 265 in platform storage 26 and computer platform 12 may utilize this list of available WLAN networks immediately or substantially immediately upon resuming operation from sleep mode.

WLAN interface unit 28 may function as dictated by programs and controls executed by computer platform 12 when it is in operational or full-power mode. When computer platform 12 switches into sleep or other low-power mode WLAN interface unit 28 may be notified accordingly (line 222, decision point 252). Upon a trigger (line 222) WLAN interface unit 28 may switch into a special sleep or low-power mode (block 254) in which WLAN interface unit 28 remains powered (or may be intermittently powered). WLAN interface unit 28 may scan for available wireless communication channels and/or networks (block 256), may detect available wireless communication networks (block 258) and may record detected available wireless communication channels and/or networks (for example in a list that may be stored in list storage location 286, in for example WLAN interface unit storage 284) (block 260). The list may be stored outside of WLAN interface unit 28, e.g., in a storage location within computer platform 12 which is not affected by a low power mode. When the stages of blocks 254-260 end, WLAN interface unit 28 may check if it should switch from its sleep mode to an operational mode (decision point 262), based on the signal received in trigger line 224 (FIG. 2A). If line 224 does not trigger, WLAN interface unit 28 remains in its non-scanning mode and after a definable delay period T_{d} (block 264) the operations of blocks 256-260 may be repeated. If, in decision point 262, a trigger is provided (line 224) WLAN interface unit 28 may switch out of its special sleep mode and resumes to its operational mode (block 266) in which it may function as dictated by programs and controls operative when computer platform 12 is in operational mode. When WLAN interface unit 28 is in the delay period (block 264), it may be switched into a sleep or any other low-power mode and thus save power. WLAN interface unit 28 may hold in storage location 286, at any time during sleep mode of computer platform 12, a list of available WLAN communication networks, that was last updated no longer than T_{d} ago. In other embodiments, a WLAN interface unit need not cycle in and out of a sleep mode. In other embodiments, other methods for handling the low power mode and triggers of the various components of the system may be used.

The sequence of operations 254-262 may be repeated regularly as a sequence once each fixed, equal or/and changeable period of time. Before the sequence WLAN interface unit 28 may be switched out of a low power mode and after WLAN interface unit 28 may be switched into a low power mode, but the power mode switching of WLAN interface unit 28 may not be performed in some embodiments. For example, a schedule for operating WLAN interface unit 28 may include operating it regularly as a sequence once each fixed, equal or changeable period of time. The interval between periods of operation within the schedule may be longer than the actual operation of the WLAN interface unit 28.

When computer platform 12 or some or all of its components (e.g., the processor and memory) are changed to an operational mode, the processor may use the set of available networks to connect to a network. When computer platform 12 resumes operation from sleep mode, for example as a result of a trigger received from, for example, an I/O device such as a keyboard or a mouse and stores the list of available WLAN networks which is received from WLAN interface unit 28 local storage in storage 265, computer platform 12 may immediately or substantially immediately use this list. Accordingly, the need to begin a process of scanning for available WLAN networks upon waking may be eliminated and delay time due to waiting to for a WLAN interface unit to begin and finish scanning for available WLAN networks may be eliminated. In some embodiments, platform 12 may use the list without a transfer of the list from WLAN interface unit 28.

According to some embodiments of the present invention delay time T_{d} may be defined by the producer or configurer of computer platform 12 or by its user, for example within defined lower and upper limits (lower and upper limits need not be used). The longer T_{d} is, the more power may be saved, as the operation WLAN interface 28 unit during sleep mode of computer platform 12 may occur between larger intervals; however, the quality of the update of the recorded list of available WLAN networks may become lower. Similarly a smaller T_{d} may result in a more updated list of available WLAN networks but may consume more power. According to embodiments of the present invention the lower limit of T_{d} if used may be somewhat longer than a maximal predicted scanning time of a maximal predicted number of available WLAN networks. An upper limit for T_{d} may in some embodiments be set to be smaller than the shorter period of time of computer platform 12 staying in sleep mode. Typically, T_{d} is set to be longer than the time it takes to perform the sequence of switching on WLAN interface 28, scanning, and recording.

Although the scope of the present invention is not limited in this respect, the wireless communications technologies used with embodiments of the present invention may include radio frequency (RF) and infrared. Non-limiting examples of RF wireless standards are protocols, such as, for example, Bluetooth, IEEE-Std 802.11a, IEEE-Std 802.11b, 1999 edition, IEEE-Std 802.11g and HomeRF. Non-limiting examples of infrared light signals are protocols, such as, for example, InfraRed Data Association (IrDA) standard.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A computer platform comprising:
a processor;
a storage device; and
a wireless communication interface unit;
wherein when said processor and said memory are in a low power mode said wireless communication interface unit is operable to scan for a set of available networks and record the set of available networks; and
wherein when the processor and memory are changed to an operating mode, the processor uses the set of available networks to connect to a network.

2. The system of claim 1, wherein said wireless communication interface unit comprises an internal controller.

3. The system of claim 2, wherein said wireless communication interface unit comprises an internal memory.

4. The system of claim 1, wherein said wireless communication interface unit is adapted to, when said processor and said memory are in a low power mode, repeatedly perform the sequence of:
switching from a first mode into a second mode said second mode being an active mode;
performing said scan; and
switching into said first mode.

5. The system of claim 4, wherein said sequence is performed once every configurable period of time.

6. The system of claim 4, wherein said configurable period of time is substantially longer than the time taken for performing said sequence.

7. The system of claim 1, wherein upon switching of said processor and said memory into an active mode, said internal memory of said wireless communication interface unit transfers the set to said memory of said computer platform.

8. A method comprising:
when a computer platform is in a low power mode, repeatedly performing in a wireless communication interface unit associated with said computer platform a sequence comprising:
switching from a first mode into a second mode said second mode being an active mode;
scanning available wireless communication networks;
detecting one or more available wireless communication networks;
recording the detected available wireless communication networks in an internal memory of said wireless communication interface unit; and
switching said wireless communication interface unit into said first mode.

9. The method of claim 8 wherein said sequence further comprises, when said platform is switched from said low power mode into an active mode, transferring a list comprising said detected available wireless communications networks from said internal memory of said wireless communication interface unit to a memory of said computer platform.

10. The method of claim 9 comprising activating said sequence at scheduled time periods.

11. The method of claim 10, wherein the interval between said time periods is longer than the time it takes to perform said sequence.

12. A system comprising:
a computer platform; and
a wireless communication interface unit associated with the computer platform;
wherein said wireless communication interface unit is operable when said computer platform is in a low power mode.

13. The system of claim 12, wherein said wireless communication interface unit comprises an internal controller.

14. The system of claim 13, wherein said wireless communication interface unit comprises an internal memory.

15. The system of claim 12, wherein said wireless communication interface unit is to perform a sequence when said computer platform is in a low power mode, said sequence comprising:
scanning for available wireless communications networks;
detecting one or more available wireless communications networks; and
recording the detected available wireless communications networks in a memory.

16. The system of claim 15, wherein said sequence is performed at scheduled periods of time.

17. The system of claim 15, wherein the interval between said periods of time is longer than the time taken for performing said sequence.

18. The system of claim 15, wherein upon switching of said platform into an active mode, said internal memory of said wireless communication interface unit transfers a list comprising said detected available wireless communications networks to a memory of said computer platform.

19. The system of claim 15, wherein before said sequence is performed said wireless communications unit is switched out of a low power mode and after said sequence is performed said wireless communications unit is switched into said low power mode.

20. The system of claim 15, wherein the platform comprises a memory and a processor.
